(19) United States
(12) Patent Application Publication
(10) Pub. No.: US 2002/0184365 A1
(43) Pub. Date: Dec. 5, 2002

(54) Method of creating a model of a system on a network

(76) Inventor: John William Lumley, Bristol (GB)

Correspondence Address: HEWLETT-PACKARD COMPANY, Intellectual Property Administration, P.O. Box 272400, Fort Collins, CO, 80527-2400, US

(21) Appl. No.: 10/115,775

(22) Filed: Apr. 5, 2002

(30) Foreign Application Priority Data
Jun. 4, 2001 (GB) 0113560.7

(51) Int. Cl. G06F 15/173

(52) U.S. Cl. 709/224

(57) ABSTRACT

A method of creating a model of a system (12, 13, 14) on a network (10) the method including connecting to the network (10) a monitoring means (25) which monitors communication messages passing between the system (13, 14, 15) and another network component (33), to collect information about the system (12, 13, 14), the monitoring means (25) being adapted to use the information to create or update a model (28) of the system (12, 13, 14), and the method including analysing the model (28) to advertise the capability of the system.

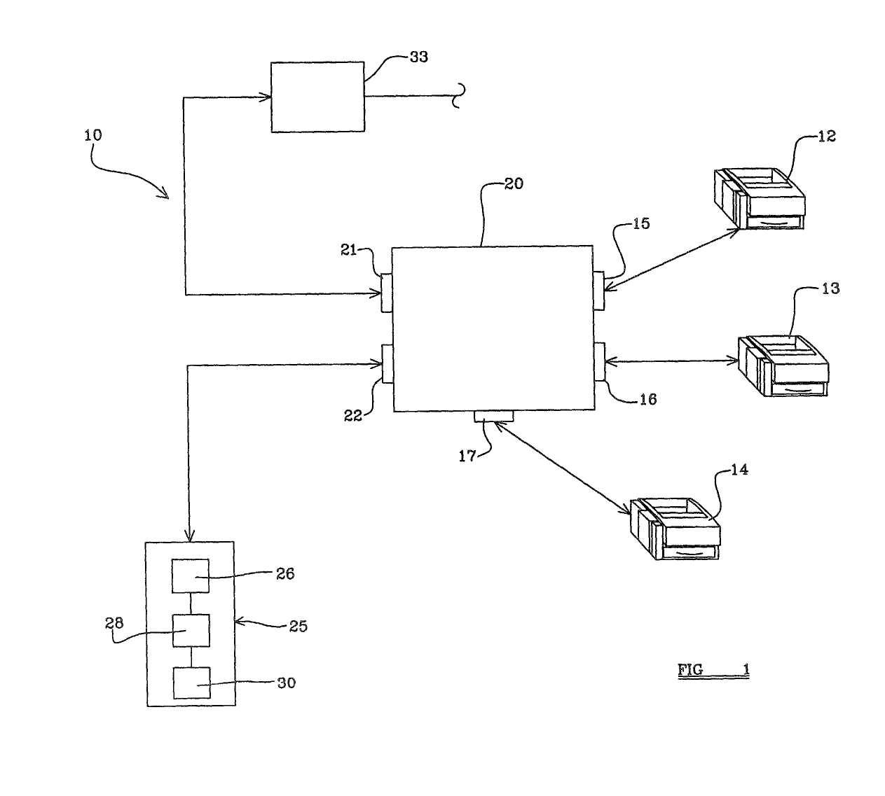

This invention relates to a method of creating a model of a system on a network. More particularly but not exclusively the invention relates to such a method for creating a model of a printing system including a cluster of print engines on a network.

Such a model is required to enable planning of printing jobs to be achieved for critical business processes, particularly across the shared resource of a cluster of print engines. Whereas it would be possible to send communications e.g. from a host to the print engines to enquire about the print engine performance, this can interfere with printing functionality hence affecting the efficiency of printing, and accordingly it is preferred for a model of the system to be available for such enquiries.

It is known manually to create a model of a printing system for use in planning the allocation of print jobs, but the creation of such models is tiresome, error-prone and the model is unable to model the system dynamically, i.e. as variations in the system composition occur. For example as a print engine is brought on-line, or is switched off-line, the manual model would require manual up-dating.

According to a first aspect of the invention we provide a method of creating a model of a system on a network the method including connecting to the network a monitoring means which monitors communication messages passing between the system and another network component, to collect information about the system, the monitoring means being adapted to use the information to create or update a model of the system, and the method including analysing the model to advertise the capability of the system.

Thus a model may be created without significant human interaction, and moreover, by creating a model by collecting information from communication messages passing between the system and the another network component, the model may be updated so as to track changes in the system configuration. Thus an up-to-date model is provided from which performance information may be obtained with reference to the model, so that the model may model the system dynamically. Moreover, a model is created which does not interfere with printing functionality.

The monitoring means may include an identification means which is adapted to identify in communication messages exchanged between the system and the another component of the network, high level messages from which the identity of the one or more system devices of the system can be ascertained.

Such high level messages may be identified during a network boot-up sequence when particular messages are exchanged between the system and the another component of the network, and/or during operation of the network when messages are exchanged between the system and the another component of the network.

The model may be updated immediately upon a change in the system being identified, but preferably the identification means records such changes and the method includes up-dating the model during idle periods when there are no communication messages passing between the system and the another component of the network. Thus the possibility of conflicts arising if the model simultaneously is up-dated and interrogated by another component of the network, is minimised.

In a preferred application of the method of the invention, the system includes a plurality of system devices which together provide a shared resource, the method including modelling the system such that the capability of each of the system devices may be advertised, to assist in planning the allocation of jobs to the individual devices of the system.

More particularly the plurality of system devices may include a cluster of print engines.

The system may be connected to the network at a hub through which communication messages between the system and the another component of the network pass. Conveniently the monitoring means is also connected to the hub so as to receive all communication messages passing through the hub.

The hub may be a passive hub which has a port which in use is connected to the network, and a plurality of other ports to which system devices are connected, the hub copying communication messages from any port to each of the other ports. Thus the method may include connecting the monitoring means to a port of the passive hub.

Alternatively the hub may be an intelligent hub in which the hub is configured to allow communication messages to be exchanged between only at least some of the ports, in which case the method may include connecting the monitoring means to a port of the hub, and configuring the hub to copy all communication messages between the system devices and the another component of the network to the monitoring means.

Further alternatively, the hub may be a switched hub which includes a processing means which reads destination addresses of communication messages passing through the hub, and forwards the communication messages to an appropriate port to which an addressed system device or the network is connected, the method including adapting the processing means of the hub to grant the monitoring means connected to a port of the hub, privileged read access to all communication messages passing through the hub which are being exchanged between the system and the another component of the network.

The method of the invention may include connecting the monitoring means to a network component which, from the advertised capability of the system, is adapted to plan the allocation of tasks to devices of the system.

Although the model may be interrogated by another component of the network which analyses the model to enable the capability of the system to be advertised, preferably the method includes analysing the model within the monitoring means to enable the capability of the system to be advertised to another component on the network.

In each case the advertised capability of the system, obtained by analysing the model created in accordance with the invention, can be used by another component of the network to search for new optimisations for policies for use of the shared resources of the system, or another system or device on the network.

The method of analysing the model may involve theoretical analysis which may be at least partially predictive, or an analysis of the concurrent system capability as modelled, as parameters change.

According to a second aspect of the invention we provide a network including a system on the network having a capability to perform tasks and at least another component on the network with which the system exchanges communication messages, the network including a monitoring means which monitors the communication messages passing between the system and the another network component, to collect information about the system, the monitoring means being adapted to use the information to create or update a model of the system which may be analysed to advertise the capability of the system.

The network of the second aspect of the invention may have any of the features of the network on which the method of the first aspect of the invention is performed.

According to a third aspect of the invention we provide a monitoring means for use in the method of the first aspect of the invention.

The invention will now be described with reference to the accompanying drawing which is an illustrative view of a part of a network in which the method of the invention may be performed.

Referring to the drawing there is shown a part of a network 10 which includes a cluster of print engines, 12, 13, 14 which in this example are raster-driven printers such as laser printers, although the invention may be applied to other printing systems and indeed to other systems which present a shared resource to the network 10.

The printers 12, 13, 14 are each connected to a respective printer port 15, 16, 17 of a hub 20, the hub 20 including a network port 21 which is connected to the network 10 as is well known in the art.

For the purposes of ease of explanation, the hub 20 will be described as a passive hub, in which any messages arriving at any of the printer ports 15, 16, 17 are forwarded to the network port 21, and moreover any messages addressed to any of the printers 12, 13, 14 arriving at the network port 21 are copied to all of the printer ports 15, 16, 17.

The hub 20 includes a further monitoring port 22 to which all communication messages from the network port 21 to the printer ports 16, 17, 18 are copied, and to which all communication messages from the printer ports 16, 17, 18 to the network port 21 are copied. A monitoring means 25 is connected to the monitoring port 22 to receive a copy of all of the communication messages, the monitoring means 25 including a identification means 26 the purpose of which will be described hereinafter.

The monitoring means 25, by monitoring the communication messages e.g. by recognising probes attached to software communications paths, creates a model 28 of the system of printers 12, 13, 14, which may be used upon analysis, to advertise the capability of the system without interfering with printer functionality. In a preferred arrangement, the capability of the system is determined in the monitoring means 25 by an analysing means 30, and this capability is advertised by the monitoring means 25 by sending communication messages either on its own initiative or in response to an enquiry, to another component, e.g. the component 33 as illustrated, of the network 10. The system capability communication messages may be sent directly to the other component 33, which need not be on the network 10, or through the hub 20 onto the network 10.

The other component 33 of the network 10 may be capable of using the advertised capability of the system of printers 12, 13, 14 to plan e.g. allocate, print jobs for the future. The component 33 may for example be a network server, a print spooler device which has overall control of the printing function of the network 10, or any other component which may use or cause simply to be displayed, the advertised capability of the system of printers 12, 13, 14.

It will be appreciated that within communications messages exchanged between the printers 12, 13, 14 and other components of the system, such as the component illustrated at 33, there will be high level messages from which the identity of the addressed printers 12, 13, 14 can be ascertained. By “identity” we mean the kind or even specific printer model.

Specific information concerning the identities of the printers 12, 13, 14 of the system (which may all be the same or at least some may be different and hence of different capability of others of the printers) may be obtained from particular high level communication messages exchanged during network boot-up, and/or from communications messages exchanged during when any of the printers 12, 13, 14 of the system are commanded to perform a printing operation.

Thus the identification means 26 essentially filters the communication messages arriving at monitoring port 22 to provide relevant information for use by the monitoring means 25 in building up/updating a model 28 of the system of printers 12, 13, 14 without or at least without any significant human input being required and without interfering with printer functionality. Moreover, by monitoring messages exchanged e.g. during printing, the performances of the printers 12, 13, 14 may be determined, for example to determine the status of each of the printers 12, 13, 14 and hence their capability for performing further printing operations in the future.

In one example, during a network boot-up sequence, from a messaging protocol within exchanged communication messages passing through the hub 20, the identification means 26 of the monitoring means 25 determines the identity of the printers 12, 13, 14 of the printing system, and thus the monitoring means 25 creates a model 28 of the printing system. During any subsequent printing operation e.g. commanded by the network component 33, from the communication messages passing through the hub 20, typically again high level message of the messaging protocol, the model 28 may be provided with information concerning the respective printer's or printers' performances. For example the model 28 may include information concerning the size of a print job sent to one of the printers 12, 13, 14, e.g. 200 pages to be printed by printer 12, and by monitoring messages passing from the printer 12 back through the hub 20, the model 28 may be updated, such that upon analysis by the analysing means 30, how many pages of the job have been completed may be determined, and if desired, advertised.

Thus the capability of the system to perform further print jobs can be advertised, by the monitoring means 25 sending messages to the component 33 on the network, or another component on its own initiative or in response to an enquiry. The component 33 may use the advertised capability to plan future print operations, e.g. by sending a further print job to another of the printers 12, 13, 14 of the system, or to another printing resource altogether as decided by the further component 33 in accordance with planning policies.

The analysing means 30 may be capable of analysing the model 25 and advertising the capability of the system taking into consideration the capability of a printer e.g. printer 12 currently in use, i.e. by determining the likely time the printer 12 will take to complete a current print job. This information may be determined by analysing the printer 12 performance over time, or the monitoring means 25 may be provided with information concerning major shared resources of the system of printers 12, 13, 14.

Thus the advertised capability of the system of printers 12, 13, 14 may include an indication of which particular print job is currently being processed, the likely time to completion, whether the print job is actively being printed or whether the job is still in the process of sorting, for examples only.

In accordance with the invention the model 28 of the system of printers 12, 13, 14 is created without or at least without significant human input being required, and the model 28 may dynamically be updated e.g. with printer performance data.

In the event that any printer 12, 13, 14 of the system is switched off-line, or is brought on-line the identification means 26 preferably is able to identify this from communications messages passing through the hub 20. This information is preferably recorded by the identification means 26 at least until there are no communication messages being exchanged with the printers 12, 13, 14 of the system, when the model 28 may be updated, so that the advertised capability of the system of printers 12, 13 ,14 may reflect this change accordingly. However if desired, the model 28 may be updated immediately any change in system configuration is discerned by the identification means 26 recognising high level messages in the messaging protocol.

Various modifications may be made without departing from the invention.

For example, the system of printers 12, 13, 14 described is only an example of a system on a network 10 to which the present invention may be applied. The system may thus have other than printers 12, 13, 14, and any number of devices 12, 13, 14 , including a single device, the capability of which it is desired to be modelled e.g. for use in planning the allocation of tasks.

The hub 20 need not be a passive hub 20 of the kind described, but may be an intelligent or switched hub, in which case the hub 20 will need to be configured or programmed appropriately to ensure that the monitoring means 25 is capable of monitoring all communication messages being exchanged between the printers 12, 13, 14 or other devices of the system, and at least another component on the network 10.

If desired the monitoring means 25 need not be connected to a hub 20, but may elsewhere be provided on the network 10 in a position on the communications message passing infrastructure such that the monitoring means 25 is able to monitor the exchange of communication messages between the system of printers 12, 13, 14 or other devices, and another component of the network 10.

The capabilities of the system of printers 12, 13, 14 or other devices, may be used for control, planning or mere information purposes as desired.

In place of the analysing means 30 being provided within the monitoring means 25, the model 28 may be analysed remotely, e.g. by component 33 of the network, in order to obtain an advertised capability of the system of printers 12, 13, 14 or other devices e.g. of a shared resource.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A method of creating a model of a system on a network, the system comprising a plurality of system devices which together provide a shared resource, the method including connecting to the network a monitoring means which monitors communication messages passing between the system and another network component, to collect information about the system, the monitoring means being adapted to use the information to create or update a model of the system, and the method including analysing the model to advertise the capability of the system as a resource and of each of the system devices therein.

2. A method according to claim 1 characterised in that the model is updated so as to track changes in the system configuration by monitoring communication messages passing between the system and the another network component.

3. A method according to claim 1 or claim 2 characterised in that the monitoring means includes an identification means which is adapted to identify in communication messages exchanged between the system and the another component of the network, high level messages from which the identity of the one or more system devices of the system can be ascertained.

4. A method according to claim 3 characterised in that the high level messages are identified during a network boot-up sequence when particular messages are exchanged between the system and the another component of the network, and/or during operation of the network when messages are exchanged between the system and the another component of the network.

5. A method according to claim 3 or claim 4 where appendant to claim 2 characterised in that the identification means records changes in system configuration and the method includes up-dating the model during idle periods when there are no communication messages passing between the system and the another component of the network.

6. A method according to claim 1 characterised in that the plurality of system devices includes a plurality of print engines.

7. A method according to any one of the preceding claims characterised in that the system is connected to the network at a hub through which communication messages between the system and the another component of the network pass, and the monitoring means is also connected to the hub so as to receive all relevant communication messages passing through the hub.

8. A method according to claim 7 characterised in that the hub is a passive hub which has a port which in use is connected to the network, and a plurality of other ports to which system devices are connected, the hub copying communication messages from any port to each of the other ports, the method including connecting the monitoring means to a port of the passive hub.

9. A method according to claim 7 characterised in that the hub is an intelligent hub in which the hub is configured to allow communication messages to be exchanged between only at least some of the ports, the method including connecting the monitoring means to a port of the hub, and configuring the hub to copy all communication messages between the system devices and the another component of the network to the monitoring means.

10. A method according to claim 7 characterised in that the hub is a switched hub which includes a processing means which reads destination addresses of communication messages passing through the hub, and forwards the communication messages to an appropriate port to which an addressed system device or the network is connected, the method including adapting the processing means of the hub to grant the monitoring means connected to a port of the hub, privileged read access to all communication messages passing through the hub which are being exchanged between the system and the another component of the network.

11. A method according to any one of the preceding claims characterised in that the method includes connecting the monitoring means to a network component which, from the advertised capability of the system, is adapted to plan the allocation of tasks to devices of the system.

12. A method according to any one of the preceding claims characterised in that the method includes analysing the model within the monitoring means to enable the capability of the system to be advertised to another component on the network.

13. A network including a system, the system comprising a plurality of system devices which together provide a shared resource, on the network having a capability to perform tasks and at least another component on the network with which the system exchanges communication messages, the network including a monitoring means which monitors the communication messages passing between the system and the another network component, to collect information about the system, the monitoring means being adapted to use the information to create or update a model of the system which may be analysed to advertise the capability of the system as a resource and of each of the system devices therein.

14. A network according to claim 13 having any of the features of the network on which the method of any one of claims 1 to 12 is performed.

15. A monitoring means for use in the method of any one of claims 1 to 12.
